(19) United States
(12) Patent Application Publication
(10) Pub. No.: US 2010/0155406 A1
(43) Pub. Date: Jun. 24, 2010

(54) Gas can for gas nail gun and inner bag connector for the gas can

(75) Inventor: Yu-Chuan Ho, Taichung County (TW)

Correspondence Address: BACON & THOMAS, PLLC, 625 SLATERS LANE, FOURTH FLOOR, ALEXANDRIA, VA, 22314-1176, US

(73) Assignee: SUPERIOR POWER TOOL CO., LTD., TAICHUNG COUNTY (TW)

(21) Appl. No.: 12/379,135

(22) Filed: Feb. 13, 2009

(30) Foreign Application Priority Data
Dec. 23, 2008 (TW) 97150330

(51) Int. Cl. F17C 13/04; F17C 1/00

(52) U.S. Cl. 220/583; 220/723

(57) ABSTRACT

A gas can for gas nail gun includes a can body having a top opening, a gas-filled inner bag mounted inside the can body, an inner bag connector, which has a tube holder joined to the inner bag and defining an axial through hole and a tube member that defines an air passage and is inserted through the axial through hole of the tube holder and rotatable between an unpositioned position where the tube member is removable from the tube holder and a positioned position where the tube member is locked to the tube holders, a cap fixedly fastened to the tube member and joined to the can body to block the top opening of the can body, and an air valve installed in the cap for guiding the gas out of the inner bag to the outside of the gas can.

### BACKGROUND OF THE INVENTION

1. Field of the Invention

The present invention relates to gas nail guns and more particularly, to a gas can for gas nail guns. The invention relates also to the inner bag connector of the gas can.

2. Description of the Related Art

FIG. 1 illustrates a conventional gas can for gas nail guns. According to this design, the gas can 1 comprises a metal can body 2, a gas-filled airtight inner bag 3 received inside the metal can body 2, and a connector 4 connecting the gas-filled airtight inner bag 3 and the end cap 2a of the metal can body 2 and adapted for guiding internal gas from the airtight inner bag 3 to the outside of the metal can body 2 for filling into the combustion chamber of a gas nail gun through an air valve (not shown) for combustion to produce an explosive force in driving a nail.

FIG. 2 illustrates the structure of the aforesaid connector 4. The connector 4 comprises a tube member 4a and a plug 4b. The tube member 4a is a stepped tube joined to the extended sheet material of the airtight inner bag 3. The plug 4b is plugged into the bottom side of the tube member 4a. The extended sheet material is sealed into the airtight inner bag 3 after installation of the plug 4b in the bottom side of the tube member 4a. This airtight inner bag 3 and connector 4 assembly process is done through three steps, taking much time and labor. Further, the plug 4b has an air hole 4c that limits the flow rate of gas flowing out of the airtight inner bag 3. However, vibration of the gas nail gun during a nail-driving operation may cause the plug 4b to fall from the tube member 4a, or the plug 4b may fall from the tube member 4a when aged after a long use of the gas can. When this problem happens, the connector 4 loses its gas flowrate regulating function.

### SUMMARY OF THE INVENTION

The present invention has been accomplished under the circumstances in view. It is the main object of the present invention to provide a gas can for gas nail gun, which has an improved structure of an inner bag connector that facilitates installation and assures quantitative gas flow rate control.

To achieve this and other objects of the present invention, a gas can for gas nail gun comprises a can body, which has an opening, an inner bag mounted inside the can body and filled with a gas, an inner bag connector, which comprises a tube holder that is joined to the inner bag and has an axial through hole axially extending through the top and bottom sides thereof, and a tube member that defines an air passage air communication with the inner bag and is inserted through the axial through hole of the tube holder and rotatable relative to the tube holder between an unpositioned position where the tube member is removable from the tube holder and a positioned position where the tube member is locked to the tube holders, a cap fixedly fastened to the tube member and joined to the can body to block the opening, and an air valve installed in the cap for guiding the gas out of the inner bag to the outside of the gas can.

To enhance the connection stability between the tube member and tube holder of the inner bag connector, the tube holder is made having at least one axial sliding groove extending along the axial through hole, and the tube member is made having at least one locating block protruded from the bottom side and insertable through the at least one axial sliding groove of said tube holder. After rotation of the tube member relative to the tube holder to the positioned position, the at least one locating block is hooked on the bottom side of the tube holder to prohibit separation of the tube member from the tube holder.

Further, to prevent gas leakage, the tube member is made having a stop flange extending around the periphery, and a seal ring is set in between the tube holder and the stop flange of the tube member.

### BRIEF DESCRIPTION OF THE DRAWINGS

FIG. 1 is a sectional elevation of a gas can according to the prior art.

FIG. 2 is a schematic drawing showing the structure of the inner bag connector of the gas can according to the prior art.

FIG. 3 is a sectional view of a gas can in accordance with a first embodiment of the present invention.

FIG. 4 is an exploded view of the inner bag connector of the gas can in accordance with the present invention.

FIG. 5 is a perspective assembly view of the inner bag connector in accordance with the present invention.

FIG. 6 is another perspective assembly view of the inner bag connector in accordance with the present invention when viewed from another angle.

FIG. 7 is an end view of the inner bag connector according to the present invention, showing the tube member in the unpositioned position.

FIG. 8 is a perspective view of the inner bag connector according to the present invention, showing the tube member in the positioned position.

FIG. 9 is an end view of FIG. 8.

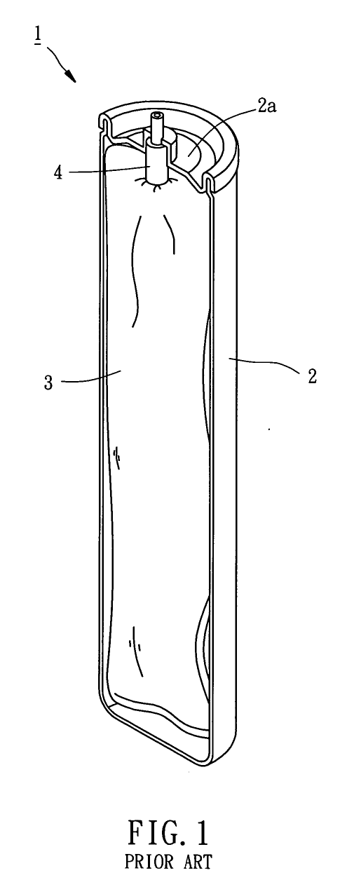

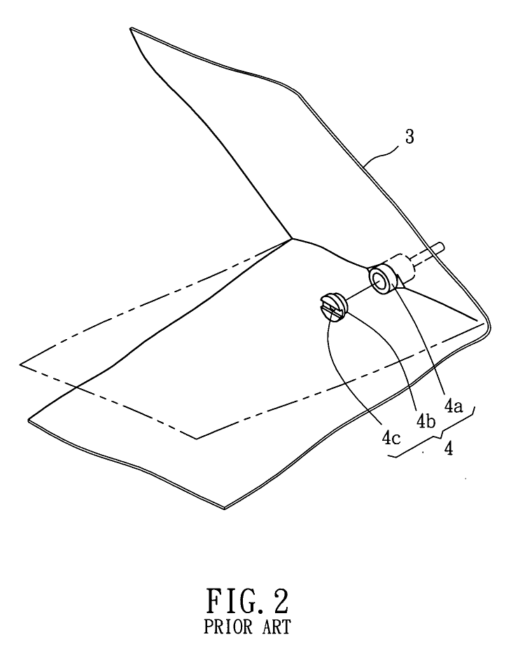

### DETAILED DESCRIPTION OF THE INVENTION

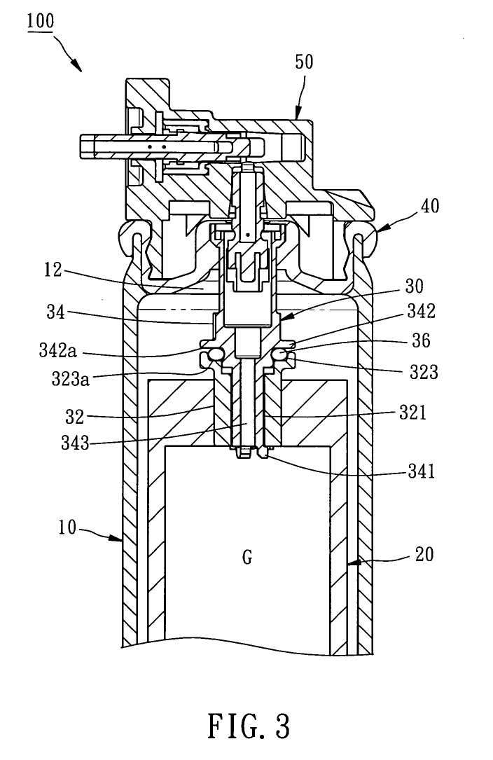

Referring to FIG. 3, a gas can 100 is shown for use in a gas nail gun. The gas can 100 comprises a can body 10, an inner bag 20, an inner bag connector 30, a cap 40, and an air valve 50.

The can body 10 is made of a metal material having an opening 12 in the top side thereof.

The inner bag 20 is an airtight bag made of, for example, aluminum foil. The inner bag 20 is filled with a gas G and mounted inside the can body 10.

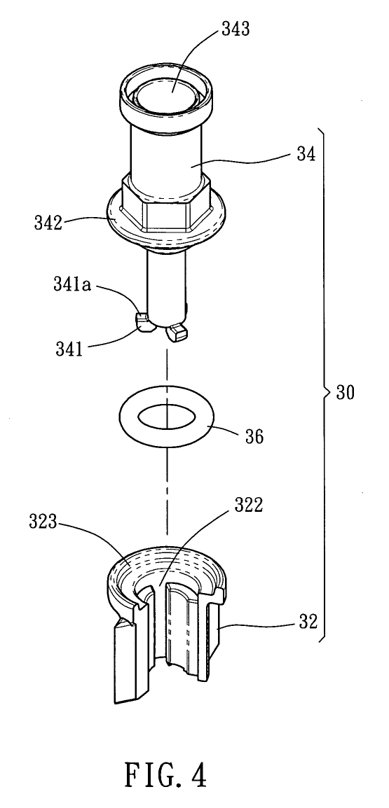

Referring also to FIG. 4, the inner bag connector 30 comprises a tube holder 32, a tube member 34, and a seal ring 36.

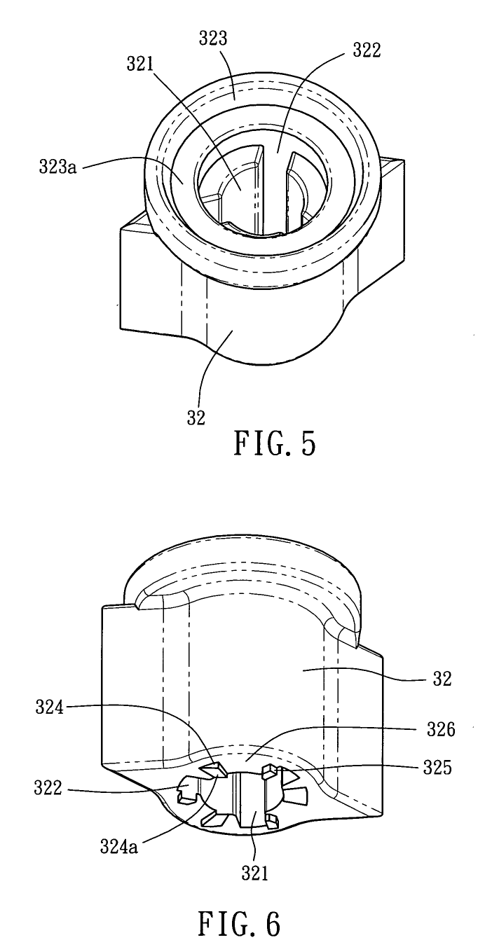

The tube holder 32 is joined to the inner bag 20 by means of a high-frequency heat sealing process. Referring also to FIGS. 5 and 6, the tube holder 32 has an axial through hole 321 axially extending through the top and bottom sides thereof, three axial sliding grooves 322 equiangularly spaced around the axial through hole 321, a top receptacle 323 located on the top side, a first stop face 323a defined in the top receptacle 323, three constraint blocks 324 and three stop blocks 325 alternatively protruded from the bottom side and equiangularly spaced from one another around the axial through hole 321, and a plurality of positioning surface portions 326 respectively defined between each constraint block 324 and each adjacent stop block 325. Further, each constraint block 324 has a beveled bottom face 324a.

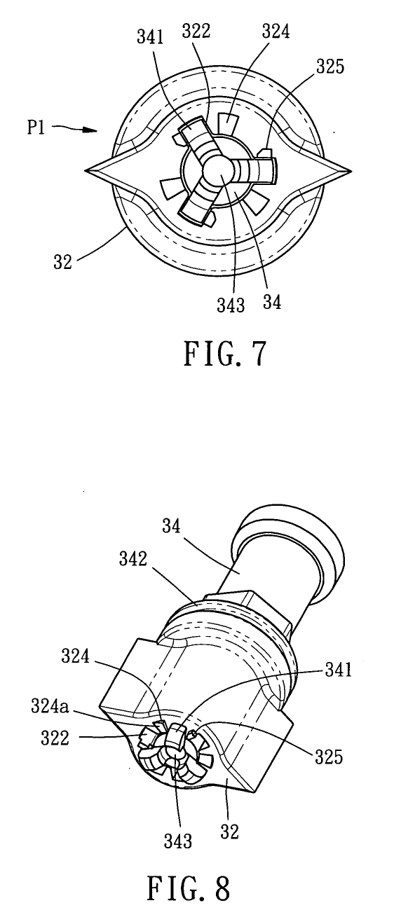

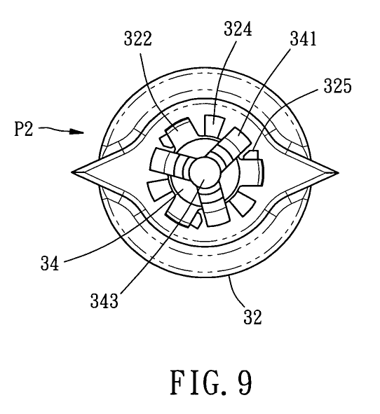

The tube member 34 has three locating blocks 341 radially outwardly protruded from the bottom side and equiangularly spaced from one another. When inserting the tube member 34 into the axial through hole 321 of the tube holder 32, the locating blocks 341 are respectively moved along the axial sliding grooves 322. Each locating block 341 has an abutment face 341a. After insertion of the tube member 34 through the axial through hole 321 of the tube holder 32, the tube member 34 can be rotated between an unpositioned position P1 shown in FIG. 7 and a positioned position P2 shown in FIGS. 8 and 9. When the tube member 34 is in the unpositioned position P1, the tube member 34 can be separated from the tube holder 32. When rotating the tube member 34 relative to the tube holder 32 after its insertion through the axial through hole 321 of the tube holder 32, the locating blocks 341 are respectively moved along the beveled bottom faces 324a of the constraint blocks 324 of the tube holder 32 over the respective constraint blocks 324 to the positioned position P2 where the abutment faces 341a the locating blocks 341 are respectively abutted against the positioning surface portions 326 of the tube holder 32. At this time, each locating block 341 is stopped between one constraint block 324 and one stop block 325 of the tube holder 32, prohibiting escape of the tube member 34 from the tube holder 32. The tube member 34 further has a stop flange 342 extending around the periphery on the middle. The stop flange 342 defines a second stop face 342a that faces the first stop face 323a in the top receptacle 323, and an axial gas passage 343 extending through the top and bottom sides thereof in air communication with the inside space of the inner bag 20.

The seal ring 36 is a rubber ring mounted in the receptacle 323 of the tube holder 32 and stopped between the first stop face 323a in the top receptacle 323 and the second stop face 342a of the stop flange 342 of the tube member 34. The seal ring 36 is squeezed to deform elastically when the tube member 34 is rotated relative to the tube holder 32 to move the locating blocks 341 over the respective constraint blocks 324. After the locating blocks 341 have been moved over the respective constraint blocks 324, the seal ring 36 slightly returns toward its former shape and is still kept in a compressed status to effectively seal the gap between the tube member 32 and the tube holder 34, avoiding leakage of the gas G from the inner bag 20.

The cap 40 is a metal member fixedly fastened to an upper part of the tube member 34 and joined to the can body 10 to block the opening 12.

The air valve 50 is of the known design installed in the cap 40 for controlling flowing of the gas G out of the inner bag 10 through the inner bag connector 30 to the combustion chamber in the gas nail gun to which the gas can is attached.

As stated above, simply by means of inserting the tube member 34 through the tube holder 32 and rotating the tube member 34 relative to the tube holder 32, the installation of the inner bag connector 30 is done. This inner bag connector installation procedure is quite simple. Further, by means of squeezing the seal ring 36 to deform, gas leakage is prohibited.

Although a particular embodiment of the invention has been described in detail for purposes of illustration, various modifications and enhancements may be made without departing from the spirit and scope of the invention. Accordingly, the invention is not to be limited except as by the appended claims

What is claimed is:

1. A gas can, comprising:
a can body, said can body comprising an opening;
an inner bag mounted inside said can body and filled with a gas;
an inner bag connector, said inner bag connector comprising a tube holder joined to said inner bag, said tube holder comprising an axial through hole axially extending through top and bottom sides thereof, and a tube member inserted through said axial through hole of said tube holder and rotatable relative to said tube holder between an unpositioned position and a positioned position, said tube member being removable from said tube holder when in said unpositioned position, said tube member being locked to said tube holder when in said positioned position, said tube member comprising an air passage kept in air communication with said inner bag;
a cap fixedly fastened to said tube member and joined to said can body to block said opening; and
an air valve installed in said cap for guiding said gas out of said inner bag to the outside of said gas can.

2. The gas can as claimed in claim 1, where said inner bag connector further comprises a seal ring set in between said tube holder and said tube member to prohibit leakage of said gas.

3. The gas can as claimed in claim 2, wherein said tube holder comprises at least one axial sliding groove axially extending through the top and bottom sides thereof in communication with and along said axial through hole; said tube member comprises at least one locating block protruded from a bottom side thereof and insertable through said at least one sliding groove of said tube holder upon insertion of said tube member through said axial through hole, said at least one locating block being hooked on the bottom side of said tube holder when said tube member is in said positioned position.

4. The gas can as claimed in claim 3, wherein said tube holder comprises at least one constraint block and at least one stop block, each said constraint block comprising a beveled bottom face; each said locating block of said tube member is moved along the beveled bottom face one said constraint block over the respective constraint block and stopped in between one said constraint block and one said stop block when said tube member is rotated relative to said tube holder from said unpositioned position to said positioned position.

5. The gas can as claimed in claim 4, wherein said tube holder comprises a receptacle located on the top side thereof, said receptacle defining therein a first stop face; said tube member comprises a stop flange extending around the periphery thereof, said stop flange defining a second stop face facing said first stop face; said seal ring is mounted in said receptacle and stopped between said first stop face and said second stop face.

6. An inner bag connector used in an inner bag of a gas can, the inner bag connector comprising:
a tube holder joined to said inner bag, said tube holder comprising an axial through hole axially extending through top and bottom sides thereof and at least one positioning surface portion located on the bottom side;
a tube member inserted through said axial through hole of said tube holder and rotatable relative to said tube holder, said tube member comprising at least one abutment face movable into engagement with said at least one positioning surface portion through a rotary motion of said tube member relative to said tube holder, a stop flange extending around the periphery thereof, and an air passage axially extending through top and bottom sides thereof in communication with said inner bag; and
a seal ring set in between said tube holder and said stop flange of said tube member to prohibit leakage of said gas.

7. The inner bag connector as claimed in claim 6, wherein said tube holder further comprises at least one axial sliding groove axially extending through the top and bottom sides thereof in communication with and along said axial through hole; said tube member comprises at least one locating block protruded from the bottom side thereof and insertable through said at least one sliding groove of said tube holder, said at least one locating block carrying said at least one abutment face.

8. The inner bag connector as claimed in claim 7, wherein said tube holder comprises at least one constraint block protruded from the bottom side thereof, each said constraint block comprising a beveled bottom face, said at least one locating block of said tube member being moved along the beveled bottom face of each said constraint block and forced into engagement with said at least one positioning surface portion of said tube holder.

9. The inner bag connector as claimed in claim 8, wherein said tube holder further comprises at least one stop block protruded from the bottom side thereof adapted for stopping said at least one locating block in abutment with said at least one positioning surface portion.

10. The inner bag connector as claimed in claim 6, wherein said tube holder further comprises a receptacle located on the top side thereof, said receptacle defining therein a first stop face; said stop flange of said tube member defines a second stop face facing said first stop face; said seal ring is mounted in said receptacle and stopped between said first stop face and said second stop face.
